(19) United States
(12) Patent Application Publication
(10) Pub. No.: US 2010/0211832 A1
(43) Pub. Date: Aug. 19, 2010

(54) SYSTEM FOR PROCESS AUTOMATION WITH A PLURALITY OF INTELLIGENT SENSOR AND A METHOD FOR CALIBRATING THE SENSORS

(75) Inventors: Stephan Buschnakowski, Chemnitz (DE); Tobias Mieth, Dresden (DE); Sven-Matthias Scheibe, Dresden (DE)

Correspondence Address: BACON & THOMAS, PLLC, 625 SLATERS LANE, FOURTH FLOOR, ALEXANDRIA, VA, 22314-1176, US

(73) Assignee: ENDRESS + HAUSER CONDUCTA GESELLSCHAFT FÜR MESS- UND REGELTECHNIK MBH + CO. KG, Gerlingen (DE)

(21) Appl. No.: 12/734,120

(22) PCT Filed: Oct. 8, 2008
(86) PCT No.: PCT/EP2008/063472

§ 371 Date: Apr. 12, 2010

(30) Foreign Application Priority Data
Oct. 15, 2007 (DE) 10 2007 049 523.6

(51) Int. Cl. G06F 15/16; G06F 3/01; G06F 11/07; G06F 17/30

(52) U.S. Cl. 714/57; 709/217; 715/760; 707/802; 714/E11.025; 707/E17.044

(57) ABSTRACT

A system for process automation with a plurality of intelligent sensors, wherein each sensor serves for determining or monitoring a physical or chemical, process variable of a medium and each sensor has a primary side, plug connector element and a secondary side, plug connector element with a sensor element. Energy supply and data communication occurs between the two plug connector elements via a releasable plug-in connector coupling, wherein associated with each sensor is a Web service interface, via which the sensor is connectable to a wide area network (WAN) or to a local area network (LAN). A control unit or a server is provided, which provides at least one software for generating a virtual measurement transmitter, and wherein communication occurs between the virtual measurement transmitter and the sensors via the Web service interface.

The invention relates to a system for process automation with a plurality of intelligent sensors, as well as to a method for calibrating the intelligent sensors, wherein each sensor is used for determining or monitoring a physical or chemical process variable of a medium. Usual field devices are composed of: A sensor element that provides measurement signals, which correspond to the value of a process variable to be determined or monitored; and a transmitter, which controls the measuring of the sensor and conditions and evaluates the measurement signals delivered by the sensor.

The physical or chemical process variable can be, for example, the pH-value, conductivity, turbidity, or the concentration of a component, of the medium, the fill level, pressure, temperature, density, viscosity or the volume or mass flow of the medium. Measuring devices suitable for determining such process variables are available in a large number of variants from the members of the firm, Endress+Hauser.

DE 102 18 606 A1 discloses a field device having a potentiometric sensor, especially a pH-sensor or a redox sensor, and a transmitter, wherein a part of the intelligence in the form of a microcontroller is moved from the transmitter into the sensor. The microcontroller has the task of acquiring measurements, monitoring various relevant parameters and communicating with the transmitter via an interface. The potentiometric sensor includes: A transducer, or sensor element, which registers pH value or redox potential of a medium; and an interface, via which a measurement signal dependent on the potentiometric variable is transmitted to the measurement transmitter connected with the sensor. In addition, a digital data memory is permanently connected with the transducer; sensor specific data, in particular device data, process data and historical data are stored in the data memory, and therefore inseparably coupled with the sensor. On the one hand, it is possible to precalibrate the sensor, before it is used on site in the process for each measurement purpose; on the other hand, the sensor can be easily connected to another transmitter, without any recalibration being absolutely necessary.

The sensor described in DE 102 18 606 A1 involves two releasably interconnected components: The plug head, with which the transducer and the date memory are inseparably connected, and the plug-in connector coupling, or the sensor cable, via which the sensor is coupled to the transmitter. Digital, bidirectional, data transfer between the plug head and the plug-in connector coupling occurs contactlessly via an inductively coupling interface. Energy transfer via the contactless, inductive interface is unidirectional from the transmitter to the sensor. Corresponding potentiometric sensors are available from the assignee under the mark, MEMOSENS. It should be noted that Memosens technology is applicable not only to electrochemical sensors; it is fundamentally applicable for any sensors determining and monitoring the most varied of process variables.

WO 00/077592 A2 discloses a control system with intelligent field, and control, devices, each having a sensor and a transmitter. The system provides a virtual machine environment for running Java byte codes. Communication occurs via Ethernet. The software for controlling the individual field, and control, devices is stored in the virtual machine.

A disadvantage of the known solution is that a large hardware complexity is required for on-site control of the field, and control, devices. The interface for control of the field, or control, device is provided directly in the sensor, so that the use of a field device is limited locally to the corresponding position within the control system. Also, the Web server, via which accessing of the field, and control, devices occurs, is directly integrated in the system. Furthermore, the individual field, and control, devices are integrated into a fieldbus; via a controller, the fieldbus is connected to the Ethernet.

The known system is very complex, since the control software must be implemented for each individual field, and control, device in the virtual machine. Furthermore, the use of the sensors belonging to the individual field, and control, devices is, as already mentioned, limited to application in a defined field bus. A subsequent change of the network or the transmitter is not possible, as is necessary, for example, when the sensors have to be removed from the process and calibrated in the laboratory.

An object of the invention is to provide a system composed of a plurality of intelligent sensors and a method for calibration of intelligent sensors, in case of which the sensors can be globally accessed via existing communication systems. In particular, the data from the sensors are to be globally available with no extra effort, regardless of whether the sensors are located in the measuring process, or are in the laboratory for calibration.

The object is solved by each intelligent sensor having a primary side, plug connector element and a secondary side, plug connector element with a sensor element, wherein energy supply and data communication between the two plug connector elements takes place via a releasable plug-in connector coupling. Furthermore, each sensor is provided with a Web service interface, via which the sensor is connectable to any user network, whether this be a wide area network WAN, or a local area network LAN. Additionally, a control unit or a server is provided, which provides at least one software for generating a virtual transmitter, wherein communication between the virtual transmitter and the sensors takes place via the Web service interfaces. The previously necessary, physical, measurement transmitter is no longer used in the case of the solution of the invention. The term, ‘Web service interface’, includes an interface serving for accessing the virtual measurement transmitter. It is also possible, however, to provide the sensors with manufacturer-independent, Web service interfaces, in order to create an open system.

The sensors are preferably electrochemical sensors. However, according to the invention, all possible types of sensors can be integrated into the system of the invention. A WAN user network is preferably the Internet, while a local user network is e.g. a Fast-Ethernet network, which enables rapid implementation of the Ethernet standard.

Through the solution of the invention, it is possible to make sensors globally available and the access to the sensors thus independent of whether they are addressed in a company internal LAN or a WAN network via a PC or via a conventional transmitter. Via the Web service interface and the associated IP address, each sensor is directly addressable and accessible, e.g. for calibration or query purposes.

According to the invention, both sensors with the Memosens interface as well as also sensors with galvanically coupling interfaces are directly connectable with any network; access to the individual sensors occurs via Ethernet and, indeed, preferably via the Web browser of the user. The transmission rate for the data can easily be up to 1 Gbit/sec.

According to the invention, the sensor data are available via Internet. Furthermore, only one software transmitter, a so-called virtual transmitter, is required. This significantly reduces manufacturing costs. The virtual measurement transmitter, which, among other things, provides the control of the sensors, can be installed in any location. The only proviso is that there has to be a network connection at such location. A further advantage of the system of the invention is to be seen in the fact that laboratory setups are considerably simplified due to the missing physical, measurement transmitter. A major simplification is that existing network infrastructures can be utilized for the system of the invention.

In order that the system is protected against anonymous, unauthorized access, a user must first log in to the system. Logged in users have the opportunity to choose, depending on access authorization, between reading and/or writing accesses. After a user has navigated to the desired page, the user can select the desired sensor from a list of available sensors. The measured values of the selected sensor or other available sensor data are then displayed to the user. Exchanging of sensors during continuous measurement operation, especially for calibration purposes, is significantly facilitated. Likewise, defective sensors can be replaced with correctly functioning sensors during on-going operation.

Seen as especially advantageous is when the Web service interface is integrated into the secondary side, plug connector element. A further advantageous development of the invention system provides that the Web service interface in the plug connector element is automatically and uniquely accessible via an associated Web address. The Web service interface is preferably a serial interface linking to a wide area network WAN or to a local area network LAN. An alternative embodiment includes that a gateway, or protocol converter, is provided for the relevant network, instead of the integrated Web service interface.

The control unit is preferably a PC, a handheld, a smart phone with Internet browser or a telephone, which makes use of a corresponding server. The virtual measurement transmitter provides, in each case, the suitable interface.

As already mentioned above, it is considered to be especially advantageous, when there is provided in each secondary, plug connector element a data memory, which contains sensor-specific data, especially data for identification, for parametering, or calibrating, and, in given cases, the last measured measurement data. These data are permanently associated with the matching sensor. Here, thus, a part of the intelligence is shifted from the now virtually existing transmitter into the sensor.

In a preferred embodiment of the system of the invention, an input unit is provided, via which the user can access the virtual measurement transmitter directly. The input unit is a Web server, which is accessible via a Web browser.

The method of the invention for calibrating the sensors of the system, as defined in one or more of the claims 1-10, comprises method steps as follows:
one or more of the sensors are, for maintenance, and/or calibration, purposes, removed from the system connected via a first network and connected in a laboratory with a laboratory network;
via the Web address, the sensor is addressed in the network, and an automatic conforming of the calibration data of the sensor with the data stored in the virtual measurement transmitter is performed;
then the sensors are calibrated by the user via the Web interfaces;
the calibrated sensors are removed from the laboratory network and following finishing of the calibrating integrated back into the system and the first network, wherein the calibration data, in given cases, are stored in the data memory associated with the secondary plug connector element.

In an advantageous further development of the method of the invention, the sensor-specific actual data stored in the data memory of the secondary side, plug connector element are registered in a company-internal database and compared with stored, desired data.

Moreover, it is provided that, in the case of a deviation between the actual data and the desired data going beyond a predetermined tolerance range, a warning, or error, report is generated and output.

Additionally, it is provided that, in the case of an error report, a new sensor is ordered using a SAP connection via a corresponding interface API ‘Application Programming Interface’ of the virtual transmitter. The virtual measurement transmitter provides an application interface, via which any applications can be linked to the system. The interface PI can be utilized via different physical interfaces.

The invention will now be explained in greater detail on the basis of the appended drawing, the figures of which show as follows:

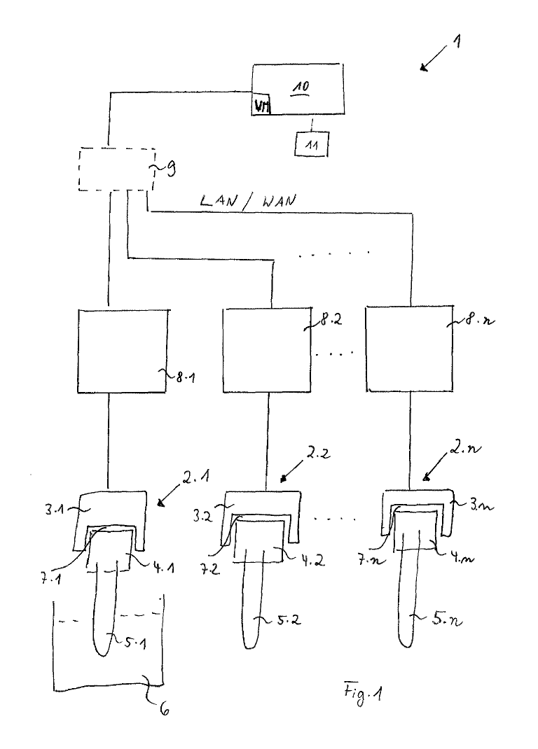

FIG. 1 a schematic representation of a first embodiment of the system of the invention;

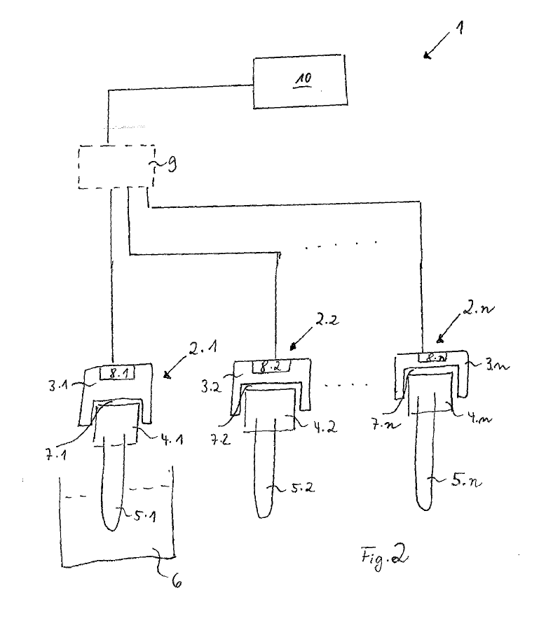

FIG. 2 a schematic representation of a second embodiment of the system of the invention; and

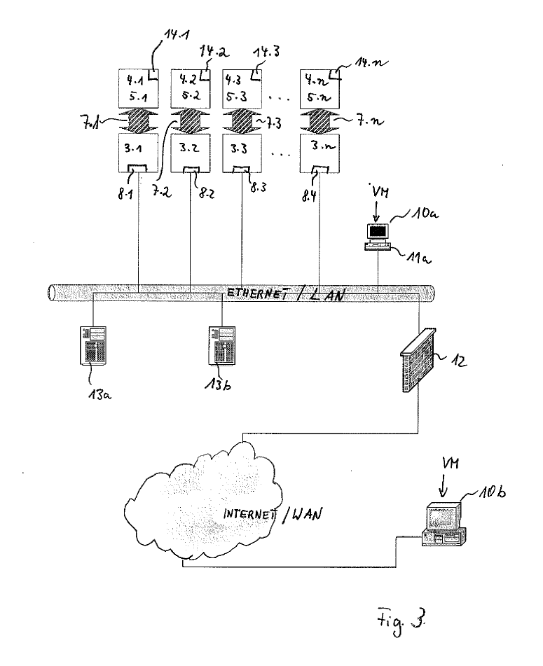

FIG. 3 a representation of how accessing of sensors occurs in the system of the invention.

FIG. 1 shows a schematic representation of a first form of embodiment of the system 1 of the invention, in which are integrated n sensors 2.1 . . . 2.n. The sensors 2.1 . . . 2.n are sensors 2.1 . . . 2.n equipped with Memosens technology: A primary side, plug connector element 3.1 . . . 3.n, or a sensor cable, is releasably coupled with a secondary side, plug connector element 4.1 . . . 4.n, or the plug head, with integrated sensor element 5.1 . . . 5.n via a plug-in connector coupling 7.1 . . . 7.n. Preferably, the plug-in connector coupling 7.1 . . . 7.n is a galvanically isolated interface, which is so embodied, that it enables communication in both directions and energy transmission unidirectionally from the primary side, plug connector element 3.1 . . . 3.n to the secondary side, plug connector element 4.1 . . . 4.n. Of course, the plug-in connector coupling 7.1 . . . 7.n can be embodied also as a galvanic interface. Reference in this connection is made to a digital sensor available under the mark, INDUCON. The sensor element 5.1 . . . 5.n is so selected, that it matches optimally the process variables to be ascertained or monitored. Available from the group of companies, Endress+Hauser, are a large number of sensors for determining a wide variety of physical and chemical process variables.

Associated with each of the sensors 2.1 . . . 2.n is a Web service interface 8.1 . . . 8.n. While in case of the embodiment of the system 1 illustrated in FIG. 1, the Web service interface 8.1 . . . 8.n is separated from the sensor 2.1 . . . 2.n, it is in the case of the embodiment illustrated in FIG. 2 integrated into the primary side, plug connector element 3.1 . . . 3.n.

Via the control unit 10 and the hub 9, a selected sensor 2.1; . . . 2.n is addressed via LAN and sensor data are read out or written into the sensor 2.1 . . . 2.n. Serving for this purpose is the input unit 11. Implemented in the control unit 10 is the virtual measurement transmitter VM, which cares for the control of all sensors 2.1 . . . 2.n and the processing and evaluation of the sensor data, to the extent that this has not already been done by the microcontroller integrated in the secondary side, plug connector element 3.1 . . . 3.n.

The sensors 2.1 . . . 2.n are integrated in a user network LAN and controlled from the virtual measurement transmitter VM, which is integrated in the control unit 10 (here, a PC). In order to enable access to each individual sensor 2.1 . . . 2.n, each sensor 2.1 . . . 2.n features a Web service interface 8.1 . . . 8.n. Via this Web service interface 8.1 . . . 8.n, the sensor 2.1 . . . 2.n can be connected to any particular WAN or LAN, user network. In the illustrated case, the LAN user network is an Ethernet network, while the WAN user network is the Internet.

The virtual measurement transmitter VM performs all functions, which in the past have been executed by each measurement transmitter associated with each individual sensor 2.1 . . . 2.n or with a limited group of sensors 2.1 . . . 2.n. According to the invention, these physical, measurement transmitters are omitted. It also does not matter in which network the individual sensors 2.1 . . . 2.n are integrated, since each sensor 2.1 . . . 2.n is uniquely identifiable and addressable via its IP address. Through the solution of the invention, it is possible to integrate the sensors 2.1 . . . 2.n into any network, LAN or WAN, via the Web interface 8.1 . . . 8.n.

As sketched in FIG. 3, it is possible to globally access the sensors 2.1 . . . 2.n via the Internet (WAN) and the Ethernet (LAN). In order to protect a company-internal user network LAN against unauthorized access, a user access authorization 12 for read and/or write access is required. Only when a user proves authorization can the user access the sensors 2.1 . . . 2.n. Various security mechanisms for global access of data of a field device are described in WO 03/023541 A2.

Since the sensors 2.1 . . . 2.n can be integrated in any network LAN or WAN, the calibration of the sensors 2.1 . . . 2.n, which usually occurs, not onsite in the process, but, instead, in the laboratory, is greatly simplified. A sensor 2.1 . . . 2.n connected in the laboratory to a network LAN can be calibrated immediately after integration into the network LAN in the laboratory via the virtual measurement transmitter VM integrated in the control unit 10a, 10b, wherein the calibration data are stored in the data memory 14.1 . . . 14.n of the sensor 2.1 . . . 2.n. If the calibrated sensor 2.1 . . . 2.n is applied subsequently back in the process, it can be accessed directly via the Web service interface 8.1 . . . 8.n both through the LAN as well as also via the WAN.

Control unit 10 can be either a PC 10a, a handheld 13a, a smart phone with Internet browser or a telephone 13b, making use of a corresponding server.

List of Reference Characters

| | |
|---|---|
| 1 | system of the invention |
| 2.1 . . . 2.n | sensor |
| 3.1 . . . 3.n | primary side, plug connector element |
| 4.1 . . . 4.n | secondary side, plug connector element |
| 5.1 . . . 5.n | sensor element |
| 6 | medium |
| 7.1 . . . 7.n | plug-in connector coupling |
| 8.1 . . . 8.n | Web service interface |
| 9 | switch/hub |
| 10 | control unit |
| 11 | input unit |
| 12 | access protection |
| 13a | handheld |
| 13b | smart phone |

1-14. (canceled)

15. A system for process automation with a plurality of intelligent sensors, wherein each sensor serves for determining or monitoring a physical or chemical process variable of a medium and each sensor element has a primary side, a plug connector element and a secondary side, and a plug connector element comprising:
a releasable plug-in connector between the two plug connector elements for energy in supply and data communication to occur:
associated with each sensor is a Web service interface, via which the sensor is connectable to a wide area user network (WAN) or to a local area user network (LAN); and
a control unit or a server, which at least provides software for generating a virtual measurement transmitter, wherein:
communication between said virtual measurement transmitter and the sensors occurs via said Web service interface.

16. The system as claimed in claim 15, wherein:
said Web service interface is integrated into the primary side, plug connector element.

17. The system as claimed in claim 15, wherein:
said Web service interface in the primary side plug connector element is automatically uniquely accessible via an associated Web address.

18. The system as claimed in claim 15, wherein:
said control unit is, for example, a PC, a handheld, a smart phone with Internet browser or a telephone with assistance of a server.

19. The system as claimed in claim 15, wherein:
the sensors are electrochemical sensors.

20. The system as claimed in claim 15, wherein:
said plug-in connector coupling is a galvanic, or a galvanically isolated, interface, especially an inductive interface.

21. The system as claimed in claim 15, wherein:
in each secondary plug connector element, a data memory is provided, in which sensor-specific data, especially data for identification, for parameterization or calibration, and, in given cases, last measured, measurement data are contained.

22. The system as claimed in claim 15, wherein:
said Web service interface is a serial interface for connection to the wide area user network (WAN) or to the local area user networks (LAN).

23. The system as claimed in claim 15, wherein:
an input unit is provided, via which a user can directly access said virtual measurement transmitter.

24. The system as claimed in claim 23, wherein:
said input unit is a Web server, which is accessible via a Web browser.

25. The method for calibrating the sensors of a system, wherein one or more of the sensors is, for maintenance, and calibration, purposes, removed from the system connected via a first network (LAN) and is connected in the laboratory with a laboratory network (LAN), comprising the steps of:
via the Web address the corresponding sensor is addressed and an automatic conforming of the calibration data of the sensor with the data stored in the virtual measurement transmitter (VM) occurs;
the sensors are calibrated by the user via the Web service interface; and
the calibrated sensors are removed from the laboratory network and following completed calibration are integrated back into the system.

26. The method as claimed in claim 25, wherein:
sensor-specific, actual data stored in the data memory of the secondary side, plug connector element are registered in a company-internal database and compared with stored, desired data.

27. The method as claimed in claim 26, wherein:
in the case of a deviation going beyond a predetermined tolerance range, an error report is issued.

28. The method as claimed in claim 27, wherein:
in the case of an error report, a new sensor is ordered by means of a SAP-link via a corresponding interface of the virtual measurement transmitter.
